(19) United States
(12) Patent Application Publication
(10) Pub. No.: US 2004/0225897 A1
(43) Pub. Date: Nov. 11, 2004

(54) Client-server architecture incorporating secure tuple space

(76) Inventor: Derk D. Norton, Louisville, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/431,097

(22) Filed: May 7, 2003

(51) Int. Cl. H04L 9/00

(52) U.S. Cl. 713/201

(57) ABSTRACT

A client-server architecture incorporates a secure tuple space in the communication path between a front end server and one or more back end servers. In response to service requests, the front end server may generate corresponding service requests, which are placed in the secure tuple space. The back end server(s) may retrieve the corresponding service requests from the secure tuple space and, in response, place a requested resource in the secure tuple space. The front end server may retrieve the resource from the secure tuple space and transmit it to a client.

### BACKGROUND

1. Technical Field

The present invention relates generally to digital computing systems and more particularly to client-server network architectures incorporating tuple spaces.

2. Background

Client-server network architectures are known. In such an architecture, an application executing on a first computing device requests a service from an application executing on a second computing device. The requesting application is typically referred to as a client, while the responding device is typically referred to as a server.

In enterprise applications, the server may reside behind one or more firewalls for security purposes. Many existing security schemes require each application to include its own security features, which increases the cost and complexity of applications. Therefore, there remains a need in the art for secure network architectures, and systems and methods for providing the same.

### SUMMARY

In an exemplary embodiment, a network architecture for use in client-server computer networks is provided. The network architecture comprises at least one front-end server connected to a communication network, the front-end server operative to receive service requests from clients, to process the requests, and to generate corresponding service requests; a plurality of back-end servers for obtaining service requests originating from a front-end server, processing the request, and supplying a resource in response to the service request; and a secure tuple space in a communication path between the front-end server and at least one back-end server.

In another exemplary embodiment, a method of computing in a client-server computing environment is provided. The method comprises: at a front-end server, receiving a service request from a client, processing the received service request, generating at the front-end server a corresponding service request, and writing the corresponding service request into a secure tuple space; at a back-end server, retrieving the corresponding service request from the secure tuple space, processing the corresponding service request, and, in response to the corresponding service request, placing a resource into the secure tuple space; and at the front-end server, retrieving the resource from the secure tuple space, and forwarding the resource to the client.

### BRIEF DESCRIPTION OF THE DRAWINGS

FIG. 1 is a schematic depiction of a conventional application architecture in a client-server network;

FIG. 2 is a schematic depiction of a modified client-server application architecture;

FIG. 3 is a high-level, schematic depiction of an exemplary secure tuple-space implementation adapted for operation in the application architecture depicted in FIG. 2;

FIG. 4 is a flowchart that illustrates operations of an external process in an exemplary interaction between an external process and the secure tuple space;

FIG. 5 is a flowchart that illustrates an exemplary process within a secure tuple space for authenticating an external process and logging the external process into a session;

FIG. 6 is a flowchart that illustrates an exemplary method for processing a read request received at a secure tuple space;

FIG. 7 is a flowchart that illustrates an exemplary method for processing a take request received at a secure tuple space;

FIG. 8 is a flowchart illustrating an exemplary method for processing a write request received at the secure tuple space; and

FIG. 9 is a flowchart illustrating an exemplary method for processing a logout request received at the secure tuple space.

### DETAILED DESCRIPTION

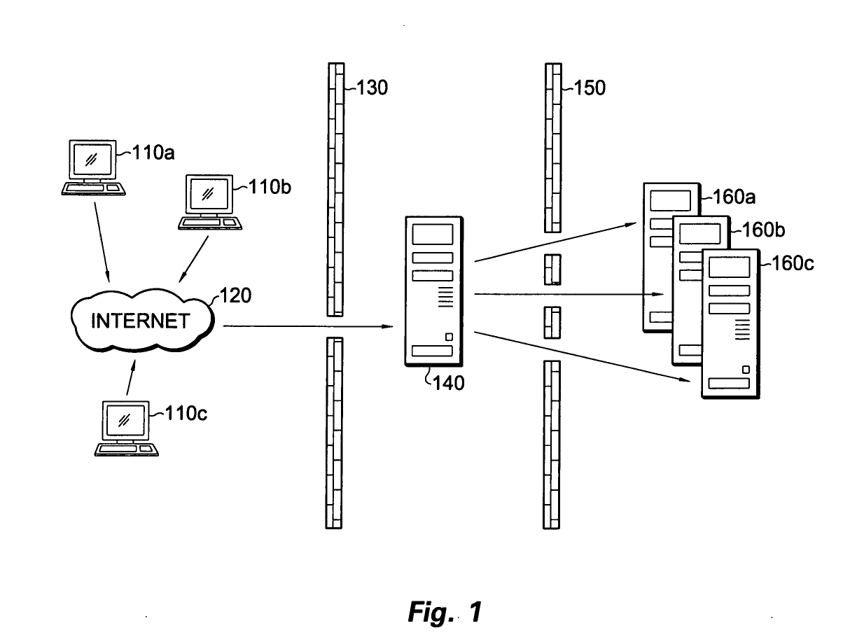

FIG. 1 is a schematic depiction of an exemplary client-server network architecture. One or more clients 110a, 110b, 110c, are connected via a suitable communication network 120 to a front-end server 140 that resides behind a firewall 130. The front-end server 140 is, in turn, connected to one or more back-end application servers 160a, 160b, 160c, which reside behind a second firewall 150.

In practice, clients 110a, 110b, 110c, generate service requests that are transmitted across the communication network 120 and the firewall 130 to the front-end web server 140. Front-end web server 140 processes service requests received from clients 110a, 110b, 110c and forwards the requests across firewall 150 to the appropriate back-end application server(s) 160a, 160b, 160c. Back-end application servers 160a, 160b, 160c receive service requests from front-end server 140, process the requests, and return the requested resource to the client via the front end server 140 and communication network 120. Back-end application servers 160a, 160b, 160c may provide email services, graphics services, content services, or other services, or combinations thereof.

Communication network 120 may be any conventional communication network. In practice the public internet is typically employed as communication network 120. Clients 110a, 110b, 110c may be conventional personal computers or workstations, personal digital assistants (PDAs) or any other suitable computing device. Clients 110a, 110b, 110c include a processor that executes software permitting clients 110a, 110b, 110c to establish and maintain a communication connection with one or more servers over communication network 120. This software may be implemented as a suitable web browser, e.g., the HOTJAVA browser made by Sun Microsystems, Inc. Firewalls 130, 150 may include any suitable commercially available firewall including, but not limited to, PIX and IOS firewall products available from Cisco Systems, the PRO series of products from SonicWall, and the FireWall-1 product from Nokia. Web servers 140, 160a, 160b, 160c may include any of the SPARC compatible processors or JAVA compatible processors available from Sun Microsystems, Inc., of Mountain View, Calif. Alternatively, web servers 140, 160a, 160b, 160c may be based on processors available from Apple, Inc., of Cupertino, Calif. or processors available from Intel Corporation, AMD and Cyrix Corporation.

The conventional architecture illustrated in FIG. 1 suffers from deficiencies that create security concerns. In particular, many application architectures require that firewall ports be opened from the front-end server 140 to each backend application component or service to allow them to be utilized. Therefore, hackers who can gain control of front-end server 140 can gain access to the back-end application servers 160a, 160b, 160c via the open ports. Such a security breach can cost entities millions, or even billions of dollars.

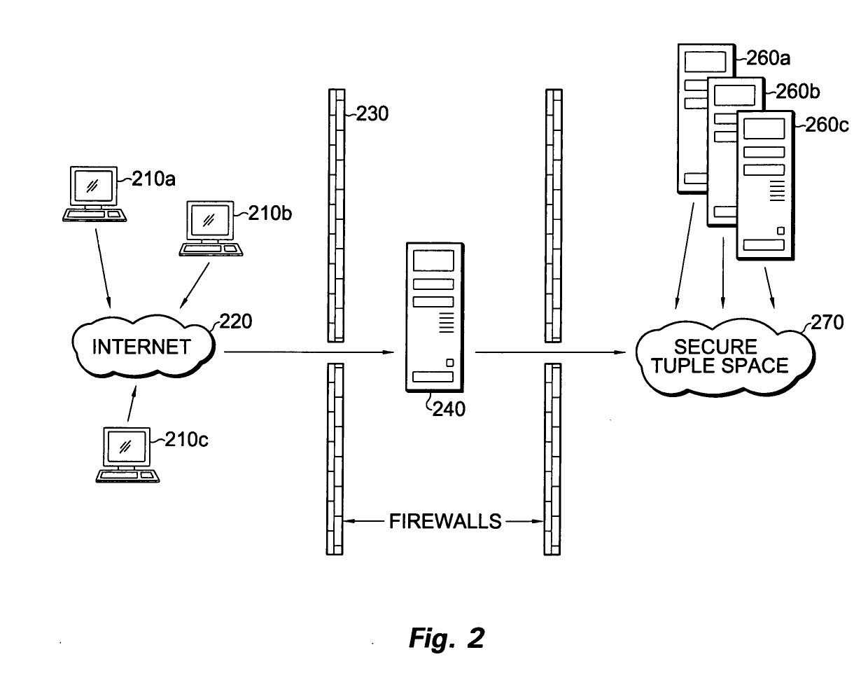

Referring now to FIG. 2 there is illustrated an exemplary application network architecture. The components of the network may be substantially the same as those illustrated in FIG. 1. One or more clients 210a, 210b, 210c, are connected via a suitable communication network 220 to a front-end server 240 that resides behind a firewall 230. The front-end server 240 is, in turn, indirectly connected to one or more back-end application servers 260a, 260b, 260c, which reside behind a second firewall 250. However, in the architecture of FIG. 2 a secure tuple space 270 is interposed in a communication path between front-end server 240 and back-end application servers 260a, 260b, 260c.

A tuple space is a collection of objects that may be shared between applications in a distributed computing system. Tuple spaces permit many active programs to communicate, although the programs may be distributed over physically dispersed machines and unaware of one another. Programs may communicate by releasing data (a tuple) into tuple space, which acts as a persistent memory that is shared across the network. Programs read, write, and take tuples (entries) from tuple space that are of interest to them. A tuple may comprise a list of values of an arbitrary length, such as (14, 7, 72) or (“a”, “xx”, “ab”) or (“Mike”, 42, 104.7). A tuple-space is a shared repository or buffer that may contain tuples. The tuple-space serves as an associative memory. Tuples in the tuple-space may be accessed by matching some or all the elements of the tuples to values or types presented in a template, which is simply a tuple set up for this matching.

In an exemplary embodiment, a secure tuple space 270 is implemented as a storage area resident on a separate server interposed in a communication path between a front-end server 240 and back-end application servers 260a, 260b, 260c. In use, front-end server 240 receives one or more service requests from clients, processes the service requests, and generates one or more corresponding requests for services from one or more back-end application servers 260a, 260b, 260c. The service request(s) from front-end server 240 are placed in a secure tuple space 270. Back-end application servers 260a, 260b, 260c retrieve the service requests from the secure tuple space 270, process the service request(s), and supply one or more resources in response to the service request. The resource(s) are placed in the secure tuple space 270. The front-end server 240 then retrieves the resource(s) from the secure tuple space 270 and forwards the resource(s) to the client(s) that initiated the service request. Interposing a secure tuple space 270 in the communication path between front-end server 240 and back-end application servers 260a, 260b, 260c severs a direct access path between front-end server and back-end application servers 260a, 260b, 260c. Therefore, a hacker who obtains access to a front-end server cannot gain a direct access path to the back-end application servers 260a, 260b, 260c.

Sun Microsystems, Inc. has implemented the concept of tuple spaces in a Java environment. A JAVASPACE is an object repository used by programs within a distributed computing system to store objects. Programs may use a JAVASPACE to store objects persistently as well as to make them accessible to other devices within a distributed computing system. JAVASPACES are described in greater detail in U.S. Pat. No. 6,032,151, entitled “Database System Employing Polymorphic Entry and Entry Matching,” which is incorporated herein by reference. One skilled in the art will appreciate that a distributed system may contain many lookup services, discovery servers, and JAVASPACES. Additional information about JAVASPACES is available in the JAVASPACE Service Specification and the JINI™ Technology Core Platform Specification, both of which are available for public distribution at Sun Microsystem's web site at www://http.sun.com. In JAVASPACE implementations, client programs may register to be notified of changes in a tuple-space.

As a broad overview, a JAVASPACE service holds entries. An entry is a typed set of objects, each of which may be tested for exact match with a template. A JAVASPACE implements four types of operations for entries: (1) write operations, which write a given entry entries into a JAVASPACE service; (2) read operations, which read an entry that matches a particular template from a JAVASPACE service; (3) take operations, which read an entry from a JAVASPACE service that matches a particular template, and removes the entry from a JAVASPACE service; and (4) notify operations, which notify a specified object when entries matching a particular template are written into a JAVASPACE service.

In addition, a JAVASPACE service implements a transaction manager to provide basic atomic transactions that group multiple operations across multiple JAVASPACE services into a bundle that acts as a single atomic operation. Transactions wrap together multiple operations. Either all modifications within the transactions will be applied or none will, whether the transaction spans one or more operations and/or one or more JAVASPACE services.

The network environment of FIGS. 1 and 2 imposes some functional parameters for implementing secure tuple spaces. To avoid reducing the performance of the network, a secure tuple space implementation should be small and simple. In addition, communication with the secure tuple space should be inbound only, and when the network uses http protocols, communication with the secure tuple space should be in http format. The secure tuple space should authenticate the client and service code prior to permitting access to the secure tuple space. In addition, the secure tuple space should scale to handle thousands of concurrent requests and should not contain any single points of failure.

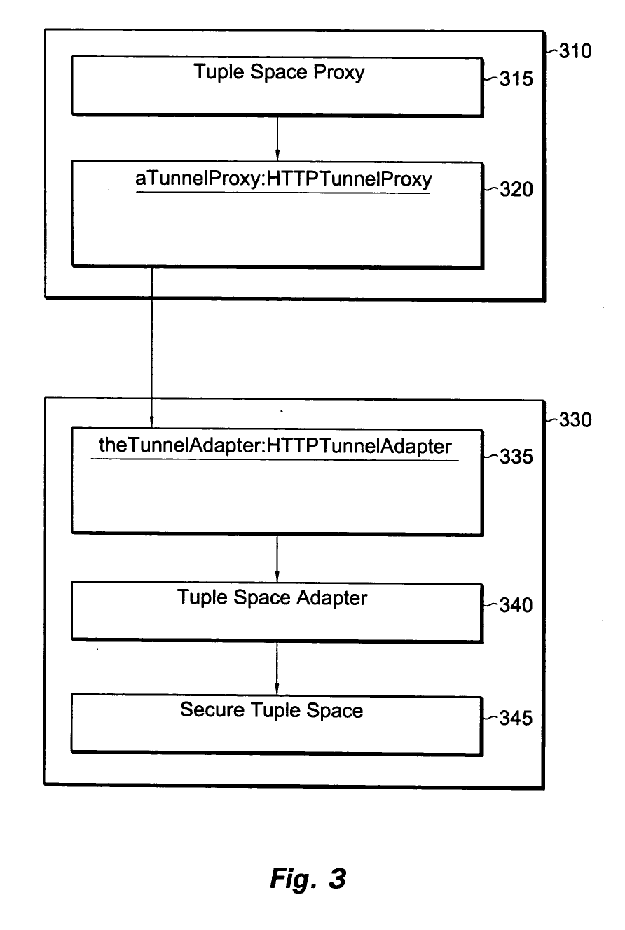

FIG. 3 is a high-level, schematic depiction of an exemplary secure tuple-space implementation adapted for operation in the application architecture depicted in FIG. 2. Referring to FIG. 3, the architecture includes a client component 310 that is implemented as a software process on a suitable computing device that interacts with the secure tuple space as a client, e.g., front-end server 240 and back-end servers 260a, 260b, 260c. Client component 310 includes a tuple space proxy component 315 that provides an application programming interface (API) that a client uses to interface with the secure tuple space. Client component 310 also includes an http tunnel proxy 320 that receives instructions from the API and transmits the instructions across the network. The instructions are transmitted using the JAVA-based remote method invocation (RMI) protocol, or another protocol, e.g., http.

The architecture also includes a server side component 330 that is implemented as a software process on a suitable computing device that hosts the secure tuple space as a server. The server side component 330 includes a tunnel adapter 335 that receives the tunneled http request from the network and formats the request for delivery to the tuple space adapter. The tunnel adapter is implemented as an http servelet that receives an http request from the http tunnel proxy and formats the request for delivery to a secure tuple space. A secure tuple space adapter 340 receives the request object from the tunnel adapter 340 and invokes a corresponding operation on the secure tuple space using, e.g., a JAVA reflection (in a JAVA implementation). A secure tuple space module 345 implements commands in the secure tuple space API. The secure tuple space module 345 receives the request from the secure tuple space adapter 340 and implements the commands to the secure tuple space. In an exemplary embodiment, the secure tuple space is implemented with a conventional database management system.

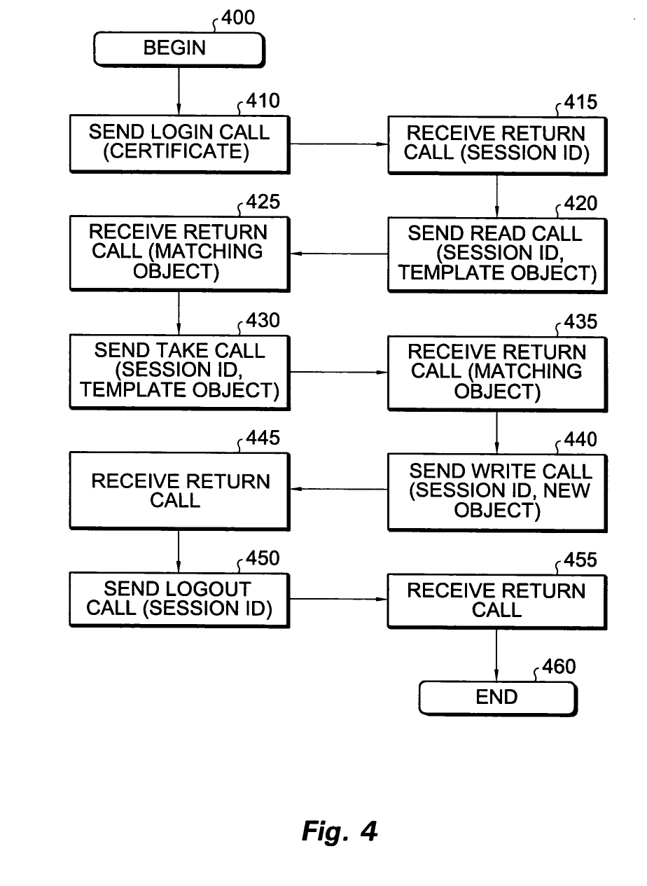

In operation, there are five primary operations that the secure tuple space exposes to the processes using it for secure communication purposes. The five processes are: login( ), read( ), take( ), write( ), and logout( ). FIGS. 4-9 are flowcharts illustrating methods of implementing these five processes between the secure tuple space and external processes. In the following description, it will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed in the computer or on other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

FIG. 4 is a flowchart that illustrates operations of an external process in an exemplary interaction between an external process the tuple space. In the architecture illustrated in FIG. 2, the external process is a process executing on front-end web server 230 or on back-end web servers 260a, 260b, 260c. For example, in response to a request from a client 210a, 210b, 210c, front end server 240 may desire to log in to the secure tuple space 270, read an entry in the secure tuple space 270, take an entry from the secure tuple space 270, and/or write an entry into secure tuple space 270.

The process begins at step 400, and at step 410 an external process sends a login call to the secure tuple space. The login call includes a certificate identifying the external process, the computing device that executes the external process, or both. At step 415 the external process receives a return call from the secure tuple space that identifies the session identifier (hereinafter session id) for the interaction with the external process. At step 420 the external process sends a read call to the secure tuple space including parameters that identify the session id and a template of an object. At step 425 the external process receives a return call from the secure tuple space that includes a matching object, assuming a matching object exists in the secure tuple space. If there is no match in the secure tuple space, then the call blocks until a matching object is located. At step 430 the external process sends a take call to the secure tuple space including parameters that identify the session id and a template of an object. At step 435 the external process receives a return call from the secure tuple space including a matching object, assuming a matching object exists in the secure tuple space. At step 440 the external process sends a write call to the secure tuple space including parameters identifying the session id and a new object. At step 445 the external process receives a return call from the secure tuple space. At step 450 the external process sends a logout call including a parameter identifying the session id, and at step 455 the external process receives a return call from the secure tuple space. The process ends at 460.

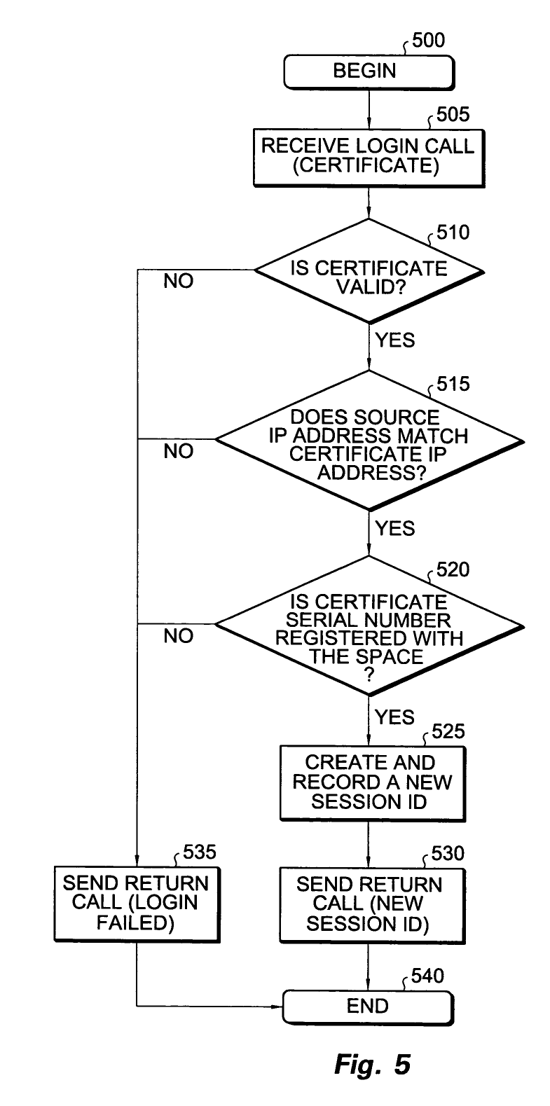

FIG. 5 is a flowchart that illustrates an exemplary process within a secure tuple space for authenticating an external process and logging the external process into a session. The secure tuple space executes this process in response to a login command, i.e., login command 410. The process begins at step 500. At step 505 the secure tuple space receives a login call from an external process including a client certificate parameter. In an exemplary embodiment, the external process must pass a valid client certificate that was generated and signed using a private key known only to the secure tuple space. The certificate must contain the same fully qualified domain name as the host that is running the external process making the request. The certificate must also contain a serial number that was generated by the secure tuple space at certificate creation time and that uniquely identifies the external process.

At step 515 the tuple space determines whether the certificate and the date are valid. This is performed, e.g., by comparing the received certificate to a list of valid certificates stored in a suitable storage medium, e.g., a database, associated with the secure tuple space. In an exemplary embodiment, the database resides on the same server that hosts the secure tuple space. In alternate embodiments the database resides on a separate computer linked to the secure tuple space server by a suitable communication link. If the certificate is invalid, then control passes to step 535, and the secure tuple space sends a return call to the external process indicating that the login has failed.

By contrast, if the certificate is valid, then control passes to step 515, and the secure tuple space determines whether the source IP address matches the IP address associated with the certificate. In an exemplary embodiment, this step is performed by comparing the IP address associated with the packets that are contained the login call to the IP address associated with the certificate stored in a suitable memory location, e.g., a database. If the source IP address does not match the certificate IP address, then control is passed to step 535, and the secure tuple space forwards a return call to the external process indicating that the login failed.

By contrast, if the source IP address matches the certificate IP address, then control passes to step 520, where the tuple space determines whether the certificate serial number is registered with the secure tuple space. Again, in an exemplary embodiment this step is performed by comparing the serial number of the received certificate with a list of serial numbers stored in a suitable storage medium, e.g., a database associated with the secure tuple space. If the certificate number is not registered with the secure tuple space, then control passes to step 535 and the secure tuple space sends a return call to the external process indicating that the login failed.

By contrast, if the certificate number is registered with the secure tuple space, then at step 525 the secure tuple space creates and records a new session id, and at step 530 the secure tuple space sends a return call to the external process including the new session id as a parameter. This session id is passed with all subsequent requests to the secure tuple space by the external process during this session. The session may expire after a configurable amount of time and the external process may be required to login again to continue. The process ends at step 540.

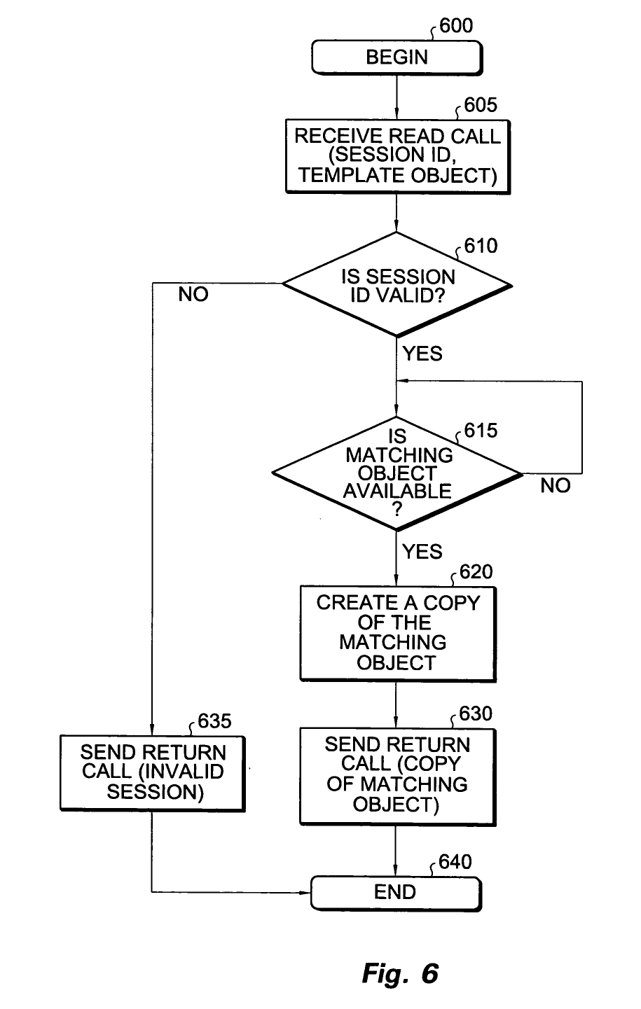

FIG. 6 is a flowchart that illustrates an exemplary method for processing a read request received at a secure tuple space. The process beings at step 600. At step 605 the secure tuple space receives a read call from an external process, including a session id and a template object. At step 610 the secure tuple space determines if the session id is valid. In an exemplary embodiment, this step is performed by comparing the session id with a list of valid session ids stored in a suitable memory location associated with the secure tuple space. If the session id is invalid, then control passes to step 635 and the secure tuple space sends a return call to the external process indicating that the session is invalid, and the process ends at 640.

By contrast, if the session id is valid, then at step 615 the secure tuple space determines whether a matching object is available in the secure tuple space. If a matching object is not available, then the request may block for an indefinite period of time until an object matching the template is written into the secure tuple space. If multiple matching objects are found, one of them is chosen at random. Optionally, a timeout feature may be implemented to terminate the process after a predetermined time waiting for a matching object.

If a matching object is available, then control passes to step 620 and the secure tuple space creates a copy of the matching object, and at step 630 the secure tuple space sends a return call that includes a copy of the matching object to the external process. This process ends at 640.

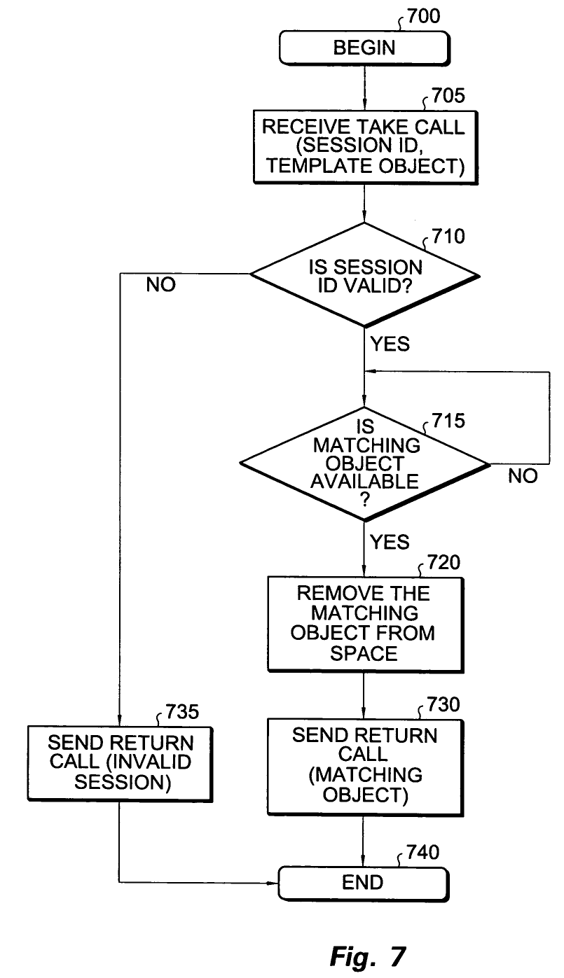

FIG. 7 is a flowchart that illustrates an exemplary method for processing a take request received at a secure tuple space. The exemplary process is substantially similar to the process for executing a read request. The process begins at step 700. At step 705 the secure tuple space receives a take call from an external process, including a session id and a template object as parameters. At step 710 the secure tuple space determines if the session id is valid. In an exemplary embodiment, this step is performed by comparing the session id with a list of valid session ids stored in a suitable memory location associated with the secure tuple space. If the session id is invalid, then control passes to step 735 and the secure tuple space sends a return call to the external process indicating that the session is invalid, and the process ends at 740.

By contrast, if the session id is valid, then at step 715 the secure tuple space determines whether a matching object is available in the secure tuple space. If a matching object is not available, then the request may block for an indefinite period of time until an object matching the template is written into the secure tuple space. Optionally, a timeout feature may be implemented to terminate the process after a predetermined time waiting for a matching object.

If a matching object is available, then control passes to step 720 and the secure tuple space removes the matching object from the secure tuple space, and at step 670 the secure tuple space sends a return call that includes the matching object to the external process. This process ends at 740.

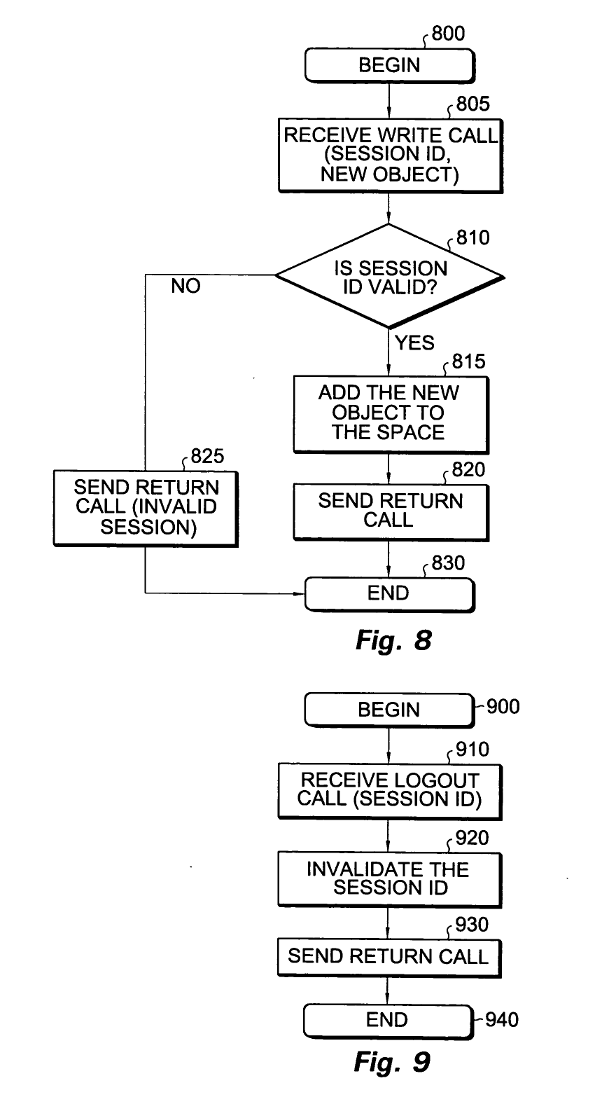

FIG. 8 is a flowchart illustrating an exemplary method for processing a write request received at the secure tuple space. The process begins at step 800. At step 810 the secure tuple space determines if the session id is valid. In an exemplary embodiment, this step is performed by comparing the session id with a list of valid session ids stored in a suitable memory location associated with the secure tuple space. If the session id is invalid, then control passes to step 825 and the secure tuple space sends a return call to the external process indicating that the session is invalid, and the process ends at 830.

By contrast, if the session id is valid, then at step 815 the secure tuple space adds the new object to the space. At step 820 the secure tuple space sends a return call to the external process, and the process ends at 830.

FIG. 9 is a flowchart illustrating an exemplary method for processing a logout request received at the secure tuple space. The process begins at step 900. At step 910 the secure tuple space receives a logout call from an external process call including a session id as a parameter. At step 920 the secure tuple space invalidates the session id. At step 930 the secure tuple space sends a return call to the external process, and the process ends at 940.

In an exemplary embodiment, front-end server 240 and back-end servers 260a, 260b, 260c interact with secure tuple space 270 in a client-server relationship. In response to each service request, front-end server 240 initiates a session with secure tuple space 270 to place a request in secure tuple space 270, e.g. a request for email for a particular system user. Back-end servers 260a, 260b, 260c also are configured to log into the secure tuple space 270 and search for requests of a specific configuration. For example, an email server may be configured to log into secure tuple space 270 and read email requests in the secure tuple space for a particular system user. If there is a request in the secure tuple space from the user, then the email server retrieves the requested email and writes it to the secure tuple space 270. The front end server 240 may then take or read the email from the space and pass it to the user. One of skill in the art will recognize that other resources may be managed in an analogous fashion.

Although systems and methods consistent with the present invention are described as operating in the exemplary distributed system and the Java programming environment, one skilled in the art will appreciate that the present invention can be practiced in other systems and other programming environments. Additionally, although aspects of the present invention are described as being stored in memory, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Sun, Sun Microsystems, the SunLogo, Java, and Java-based trademarks are trademarks or registered trademarks of Sun Microsystems Inc. in the United States and other countries.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

What is claimed is:

1. A network architecture for use in client-server computer networks, comprising:
at least one front-end server connected to a communication network, the front-end server operative to receive service requests from clients, to process the requests, and to generate corresponding service requests;
a plurality of back-end servers communicatively connected to the at least one front-end server for obtaining service requests originating from a front-end server, processing the request, and supplying a resource in response to the service request; and
a secure tuple space in a communication path between the front-end server and at least one back-end server.

2. The architecture of claim 1, further comprising a firewall in the communication path between a front-end server and the secure tuple space.

3. The architecture of claim 1, further comprising a firewall between a front-end server and the communication network.

4. The architecture of claim 1, wherein the secure tuple space resides on a dedicated server.

5. The architecture of claim 1, wherein the front-end server comprises logic instructions for converting service requests into a format compatible with the secure tuple space.

6. A method of computing in a client-server computing environment, comprising:
at a front-end server, receiving a service request from a client, processing the received service request, generating at the front-end server a corresponding service request, and writing the corresponding service request into a secure tuple space;
at a back-end server communicatively connected to the front-end server, retrieving the corresponding service request from the secure tuple space, processing the corresponding service request, and, in response to the corresponding service request, placing a resource into the secure tuple space; and
at the front-end server, retrieving the resource from the secure tuple space, and forwarding the resource to the client.

7. The method of claim 6, further comprising transmitting the corresponding service request across a firewall between the front end server and the back end server.

8. The method of claim 6, wherein the front-end server and back end servers initiate a login request to the secure tuple space.

9. The method of claim 8, wherein, in response to the login request, the secure tuple space authenticates the front end server and back end servers and generates a session id for each server that is authenticated.

10. The method of claim 6, wherein, in response to a service request, the front end server initiates a write call to write the request to the secure tuple space.

11. The method of claim 6, wherein one or more back end servers issues a take call to search the secure tuple space for an entry matching a template passed with the take call.

12. The method of claim 11 wherein the take call is blocked for a period of time if there are no matching entries in the secure tuple space.

13. The method of claim 11, wherein if an entry matching a template passed with a take call is found, then the matching object is removed from the secure tuple space and passed to the back end server for processing.

14. The method of claim 13, wherein the back end server returns the results of the processing to the secure tuple space by executing a write operation.

15. The method of claim 6, wherein, in response to a service request, the front end server initiates a take call to the secure tuple space, wherein the take call includes the original service request id.

16. The method of claim 15, wherein, in response to the take call, the secure tuple space is searched for an entry matching the request id passed with the take call.

17. The method of claim 16 wherein the take call is blocked for a period of time if there are no matching entries in the secure tuple space.

18. The method of claim 16, wherein if an entry matching a template passed with a take call is found, then the matching object is removed from the space and passed to the front end server.

19. The method of claim 6, wherein each back end server is configured to login to the secure tuple space and issue a take call for entries having a particular template.

20. The method of claim 19, wherein when a take call is successful, the back end server writes a resource from the back end server into the secure tuple space.

21. The method of claim 6, wherein a front end server or a back end server initiates a read call to the secure tuple space.

22. The method of claim 21, wherein, if an entry matching a template passed with the read call is found, then a copy of the matching object is passed from to the server that initiated the read call.
